(19) United States
(12) Patent Application Publication
(10) Pub. No.: US 2009/0236971 A1
(43) Pub. Date: Sep. 24, 2009

(54) See-through Display apparatus

(76) Inventors: Chih-Che Kuo, Tapei City (TW); Te-Fong Chan, Jhongli City (TW); Kuo-Rong Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/149,413

(22) Filed: May 1, 2008

(30) Foreign Application Priority Data
Mar. 19, 2008 (TW) 97109692

(51) Int. Cl. H01J 1/62

(52) U.S. Cl. 313/503; 313/505

(57) ABSTRACT

A see-through display apparatus includes a first substrate having a plurality of first electrodes on its upper surface, a second substrate having a plurality of second electrodes on its bottom surface. The first electrodes and the second electrodes are alternative arrangement so that a plurality of crossing areas is formed. Each crossing area forms a pixel area and has at least one electric-excited area thereon. The electric-excited areas are alternated with the transparent areas and the see-through rate of the pixel area is ranged in a predetermined range so that the display apparatus has a see-through property.

### BACKGROUND OF THE INVENTION

1. Field of the Invention

The present invention relates to a transparent display apparatus and in particular to a display apparatus having see-through characteristics and display functions.

2. Description of Prior Art

Resulting from the improvement of internet and wireless technology, mobile devices such as laptop computers, cellar phones, digital cameras, and personal digital assistants (PDA) are widely used in modern life. Since liquid crystal displays (LCD) have narrow dimensions, low mass and low power-consumption, their application in mobile products is increasing fast.

Small and medium-sized FPD (Flat Panel Display) panels for mobile products are improved to great-sized panel industry. The manufacturing processes of the great-size FPD are developed and the FPD has characteristics of high brightness, high contract, high response rate and lower energy-consuming than cathode ray tubes (CRT). FPD products have displaced CRTs in display applications, mainly because of the bulkiness of CRTs and the increasing popularity of low depth of display screen.

However, traditional displays including CRT, LCD and PDP are not transparent, i.e., a person can not see an object behind the display. When the traditional display is assembled on the shop window, objects behind the display will not be seen by observers. In other words, people can not see the information on display and the exhibit inside the shop window at the same time. Some developments produce a see-though display via a transparent substrate, transparent electrodes, and transparent fluorescence powders. However, the fluorescence powders are not 100% transparent and the light is scattered because of the shape of the powders so that the display color is gray. Furthermore, the field-emitting materials are coated on the substrate by adhesive materials and metal conductive materials. Therefore, the see-though ratio of the above-mentioned display is very low and observers can barely recognize an image through the display.

Therefore, the inventor proposes the present invention to overcome the above problems based on his expert experience and deliberate research.

### SUMMARY OF THE INVENTION

The primary object of the present invention is provided for a see-through display apparatus. The see-through display apparatus has sub-pixels and the adjacent sub-pixels are separated by a transparent area so that an observer can see through the display apparatus.

In order to achieve the above object, the present invention provides a see-through display apparatus, comprising: a substrate having a plurality of first electrodes on its top surface; an second substrate disposed on the substrate, wherein the second substrate has a plurality of second electrodes on its bottom surface, the first electrodes and the second electrodes are arranged to form a plurality of crossing areas, each crossing area defining a pixel area; and at least one electro-luminescent area disposed on each of the crossing areas; wherein a see-through ratio of each pixel area is in a predetermined range, the see-through ratio of the pixel area is determined by formula: T=(PA−EA)/PA*100%, where T is the see-through ratio of each pixel area, PA is the area of each pixel area, EA is the area of at least one electro-luminescent area on each crossing area.

Depending on the present invention, the objects behind the display apparatus can be seen by an observer in front of the display apparatus. Moreover, the observer still can see the image displayed by the display apparatus. In order to better understand the characteristics and technical contents of the present invention, a detailed description thereof will be made with reference to the accompanying drawings. However, it should be understood that the drawings and the description are illustrative but not used to limit the scope of the present invention.

### BRIEF DESCRIPTION OF THE DRAWINGS

FIG. 1 is a schematic view showing the see-through display apparatus according to the present invention.

FIG. 2 shows pixel areas defined in the see-through display apparatus according to the present invention.

FIG. 3 shows the first embodiment of electro-luminescent areas and transparent areas of the see-through display apparatus according to the present invention.

FIG. 3A shows the second embodiment of electro-luminescent areas and transparent areas of the see-through display apparatus according to the present invention.

FIG. 3B shows the third embodiment of electro-luminescent areas and transparent areas of the see-through display apparatus according to the present invention.

FIG. 3C shows the fourth embodiment of electro-luminescent areas and transparent areas of the see-through display apparatus according to the present invention.

### DETAILED DESCRIPTION OF THE INVENTION

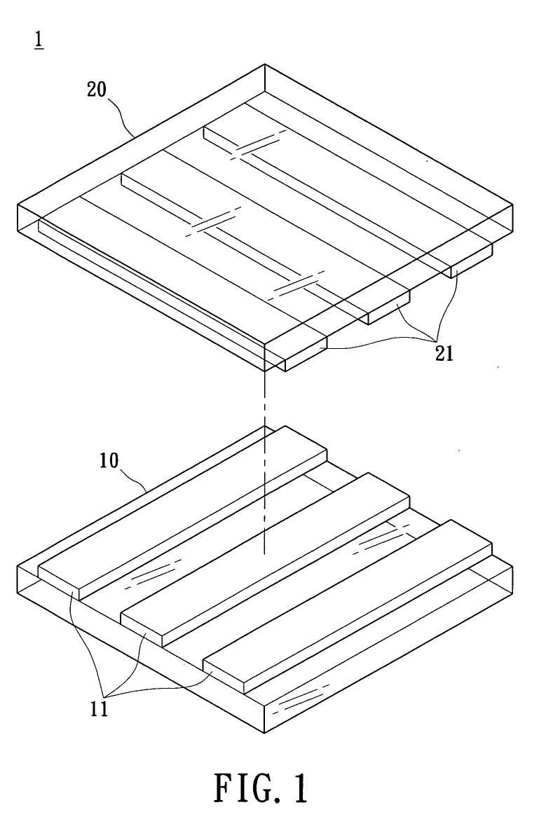

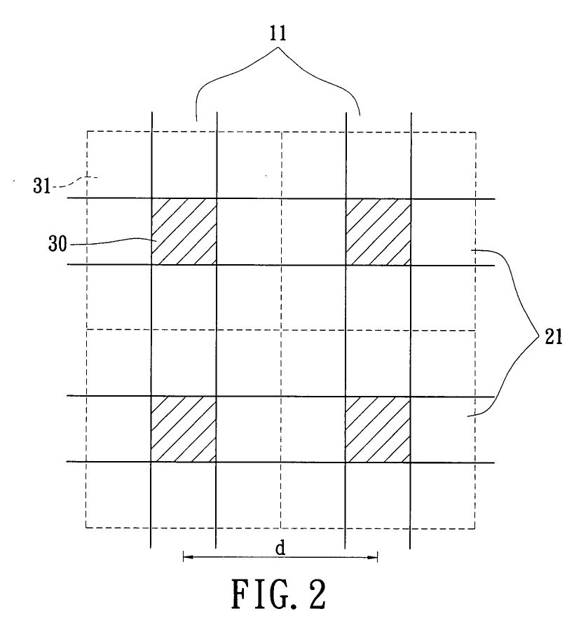

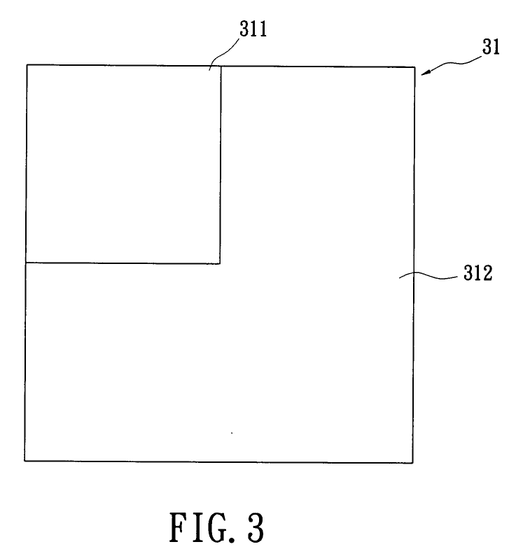

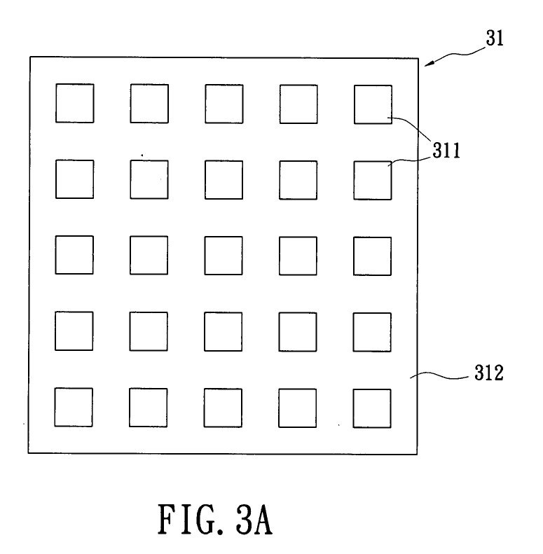

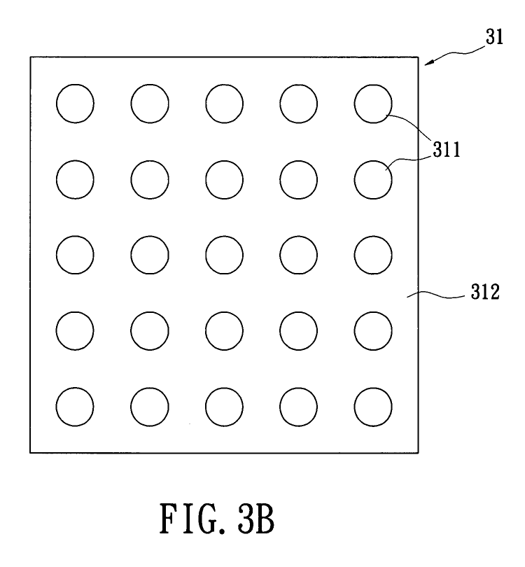

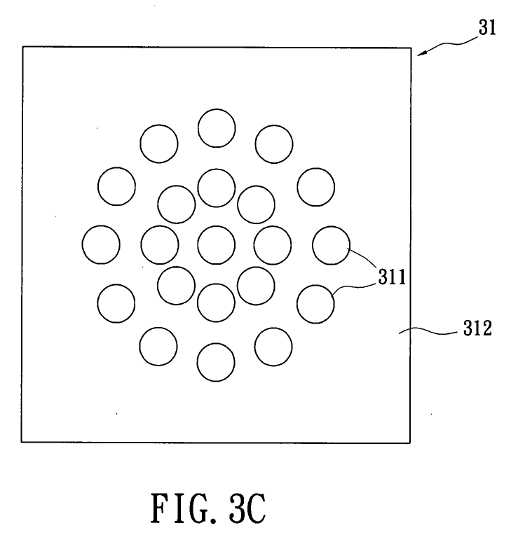

Please refer to FIGS. 1-3, the invention discloses a see-through display apparatus 1 and each of the pixels of the see-through display apparatus 1 are separated into sub-pixels so that a person can see images or subjects behind the see-through display apparatus 1. In other words, when the see-through display apparatus 1 is not powered on, people can see through the see-through display apparatus 1 and alternatively, when the see-through display apparatus 1 is powered on in order to present some images thereon, people still can recognize the subjects behind the see-through display apparatus 1. The see-through display apparatus 1 comprises a first substrate 10, a second substrate 20 and at least one electro-luminescent area 311. The first substrate 10 has a plurality of first electrodes 11 on its top surface and the second substrate 20 has a plurality of second electrodes 21 on its bottom surface. The first substrate 10 and the first electrodes 11 are constructed as a first electrode-plate. Similarly the second substrate 20 and the second electrodes are constructed as a second electrode-plate. The first electrodes 11 and the second electrodes 21 are arranged to form a plurality of crossing areas 30. In the embodiment, the first electrodes 11 are longitudinally disposed on the top of the first substrate 10 as negative electrodes and the second electrodes 21 are transversely disposed at the bottom of the second substrate 20 as positive electrodes so that crossing areas 30 can be formed by the first electrodes 11 and the second electrodes 21. Each crossing areas 30 defines a pixel area 31 by human, in other words, a “real” crossing areas 30 defines a “non-real” pixel area 31. Please note crossing area 30 is not shown in FIGS. 3-3C for simplicity. The electro-luminescent area 311 is disposed on each of the crossing areas 30, i.e., the pixel area 31. In the invention, the see-through ratio of each pixel area 31 is calculated and ranged in a predetermined range so that the light behind the see-through display apparatus 1 is not blocked and can transmit through the see-through display apparatus 1. The see-through ratio of the pixel area 31 is determined by formula: T=(PA−EA)/PA*100%, where T is the see-through ratio of each pixel area 31, and PA is the area of each pixel area 31, and EA is the area of at least one electro-luminescent area 311 on each crossing area 30.

The electro-luminescent area 311 of each pixel area 31 is coated by a plurality of phosphor powders so that the electro-luminescent area 311 will illuminate to display information when the see-through display apparatus 1 is powered on. However, because the phosphor powders are non-transparent powers, the electro-luminescent area 311 are non-transparent areas. In other words, each pixel area 31 has transparent area 312 and non-transparent area (electro-luminescent area 311) and the transparent area 312 has greater area than the non-transparent area. By arranging the transparent areas 312 and non-transparent areas (electro-luminescent areas 311) in an interval manner, diffraction occurs when light waves encounter see-through display apparatus 1 in their propagating paths, and its effect is that a person in front of see-through display apparatus 1 can see through the display apparatus 1 to see things behind the see-through display apparatus 1. Moreover, the electro-luminescent areas 311 of the each pixel area 31 perform as sub-pixel areas and people can see through the display apparatus 1 by arranging the sub-pixel areas of the each pixel area 31.

Basically, resolution quantifies how close a pair of lines or points can be to each other and still be visibly resolved. Image resolution describes the detail an image holds. The term is calculated in spatial formula, and higher resolution means more image detail and higher image quality. Discussing about spatial frequency, the resolution of human eyes is decreasing extremely in high space frequency according to the MTF (modulation transfer function) defined as a ration of image contract (Mi) divided object contract (Mo). Accordingly, each pixel area 31 is classified into transparent areas 312 and non-transparent areas (electro-luminescent areas 311) and the transparent areas 312 alter with the non-transparent electro-luminescent areas 311 for arranging the two areas 311 and 312 in a high spatial frequency. Therefore, when the see-through display apparatus 1 is not powered on, an observer can not resolve the two areas 311 and 312 of the each pixel area 31 so that light waves transmitted through the greater transparent areas 312 are observed and the light waves encounter the non-see-through electro-luminescent areas 311 is overlooked. The effect makes a phenomenon that the observer feels seeing the image behind the see-through display apparatus 1. Depending on research on MTF and regular spatial frequency, if the spatial frequency is higher, the resolution of the human eyes to observer the detail is lower. Therefore, if the transparent areas 312 and the non-transparent areas is arranged in manner of higher frequency, the obstacles (non-transparent electro-luminescent areas 311) on the light paths is not detectable for human eyes and in other words, the display apparatus 1 is transparent and can be see-through for human eyes. On the contrary, when the electro-luminescent areas 311 project light, the lighting sub-pixels can combine together to human eyes because the distances between the sub-pixels are small. Therefore, the sub-pixels perform information which is seen by a person because the spatial frequency is lower in the lighting condition. On the other hand, because the brightness of electro-luminescent areas 311 is much higher than the background light projected from the object behind the display apparatus 1 and the contract is higher, the information displayed by the electro-luminescent areas 311 can be seen by the observer.

Diffraction refers to various phenomena associated with the bending of waves when they interact with obstacles in their path. It occurs with any type of wave, including sound waves, water waves, and electromagnetic waves such as visible light, x-rays and radio waves. According to the Rayleigh Criterion invented by Lord Rayleigh and minimum resolvable distance, two images overlapped than the limitation of Rayleigh results in a blurring image. Therefore, when light behind the display apparatus 1 transmits thought the transparent area 312 and blocked by the electro-luminescent areas 311, only the transmitted light can be observed by human eyes on physical. However, the total image is diffracted to be a blurring image so that human eyes can resolve the transmitted portion (transparent area 312) and the blocked portion (electro-luminescent areas 311). Thus, the observer feels that he can see though the display apparatus 1. In other words, the present invention arranges the transparent area 312 and the electro-luminescent areas 311 in an alternative manner to produce a blurring image so that the observer can not resolve the transparent area 312 and the electro-luminescent areas 311 and the display apparatus 1 is see-through for the observer.

Furthermore, the first substrate 10 and second substrate 20 can be a transparent plate, for example a glass substrate. The electrodes 11 and 21 can be made from ITO (Indium Tin Oxides) or IZO (Indium Zinc Oxides), i.e., a transparent electrode.

Please refer to FIGS. 3 to 3C, the electro-luminescent areas 311 of the pixel area 31 (sub-pixel area) has different arrangements. The pixel area 31 has only a rectangular electro-luminescent area 311 and the remaining portion of the pixel area 31 is transparent areas 312 in the first embodiment of FIG. 3. Calculating by the preceding formula, see-through ratio of each pixel area 31 (T) is about 75%. FIG. 3A shows the second embodiment of the present invention. The pixel area 31 has a plurality of rectangular electro-luminescent areas 311 and there is a transparent area 312 between each two adjacent electro-luminescent areas 311. The see-through ratio of each pixel area 31 (T) is about 70% in the second embodiment. FIG. 3B shows the third embodiment of the present invention. The pixel area 31 has a plurality of circular electro-luminescent areas 311 and there is a transparent area 312 between each two adjacent electro-luminescent areas 311. The see-through ratio of each pixel area 31 (T) is about 80% in the third embodiment. FIG. 3C shows the fourth embodiment of the present invention. The pixel area 31 has a plurality of circular electro-luminescent areas 311 in concentric arrangement and there is a transparent area 312 between each two adjacent electro-luminescent areas 311. The see-through ratio of each pixel area 31 (T) is about 90% in the fourth embodiment. Accordingly, the each see-through ratio of each pixel area 31 (T) of the display apparatus 1 is preferably between 70% to 90% and the electro-luminescent areas 311 has display function between the above range. Therefore the display apparatus 1 can be seen-through and has a common display function for presenting images.

However, the pitch (d) between adjacent pixel areas 31 is a predetermined width and can be adjusted in the present. The width of pitch (d), for example, can be lengthened so that the MTF and regular spatial frequency is increasing and the observer can see the objects behind the display apparatus 1 more easily. For example, the width of pitch (d) is 5 mm in condition that the distance between observer and display apparatus 1 is 1 m. In other words, the width of pitch (d) can changed in order to increase the regular spatial frequency so that the display apparatus 1 performs a see-through display apparatus 1 for human eyes.

Accordingly, the display apparatus 1 is a multi-function display apparatus. The pixel areas 31 has electro-luminescent areas 311 and transparent area 312 spaced apart from one another and the see-through ratio of each pixel area 31 (T) is between 70% to 90% so that the observer can not notice the electro-luminescent areas 311 when the see-through display apparatus 1 is not powered on. On the contrary, when electro-luminescent areas 311 luminesce, observer not only can see the information displayed by the electro-luminescent areas 311 but also see the objects behind the display apparatus 1.

To sum up, the present invention has the following advantages:
1. The display apparatus 1 provides a better displaying performance. Because the electro-luminescent areas 311 and transparent area 312 space apart from one another and the see-through ratio of each pixel area 31 (T) is between 70% to 90%, human eyes will ignore the electro-luminescent areas 311 physically so that the observer feels that he can see through the display apparatus 1.
2. The display apparatus 1 is a multi-function display apparatus and includes see-through property and a common displaying function.
3. The see-through display apparatus 1 can be used for demo window or production display.

Although the present invention has been described with reference to the foregoing preferred embodiment, it will be understood that the invention is not limited to the details thereof. Various equivalent variations and modifications may occur to those skilled in this art in view of the teachings of the present invention. Thus, all such variations and equivalent modifications are also embraced within the scope of the invention as defined in the appended claims.

What is claimed is:

1. A see-through display apparatus, comprising:
a first substrate having a plurality of first electrodes on a top surface thereof;
a second substrate disposed above the first substrate and having a plurality of second electrodes on a bottom surface thereof, whereby the first electrodes and the second electrodes are arranged to form a plurality of crossing areas, each crossing area defines a pixel area; and
at least one electro-luminescent area disposed on each of the crossing areas;
wherein a see-through ratio of each pixel area T is in a predetermined range, the see-through ratio of each pixel area T being determined by formula:
T=(PA−EA)/PA*100%, where PA is the area of each pixel area, and EA is the area of at least one electro-luminescent area on each crossing area.

2. The see-through display apparatus according to claim 1, wherein the see-through ratio of each pixel area is between 70% and 90%.

3. The see-through display apparatus according to claim 2, wherein the at least one electro-luminescent area is coated by a plurality of phosphor powders.

4. The see-through display apparatus according to claim 3, wherein the at least one electro-luminescent area is a non-transparent area.

5. The see-through display apparatus according to claim 4, wherein each pixel area includes the at least one non-transparent electro-luminescent area and at least one transparent area.

6. The see-through display apparatus according to claim 5, wherein the at least one non-transparent electro-luminescent areas and the least one transparent areas are arranged at intervals.

7. The see-through display apparatus according to claim 5, wherein the at least one non-transparent electro-luminescent area is defined as a sub-pixel area.

8. The see-through display apparatus according to claim 2, wherein the substrate is transparent.

9. The see-through display apparatus according to claim 8, wherein the transparent substrate is made of glass materials.

10. The see-through display apparatus according to claim 2, wherein the second substrate is transparent.

11. The see-through display apparatus according to claim 10, wherein the transparent second substrate is a transparent metal layer.

12. The see-through display apparatus according to claim 11, wherein the transparent metal layer is made of ITO (Indium Tin Oxides) or IZO (Indium Zinc Oxides).

13. The see-through display apparatus according to claim 2, wherein a pitch between adjacent pixel areas has a predetermined length.
